(19) United States
(12) Patent Application Publication
(10) Pub. No.: US 2015/0343382 A1
(43) Pub. Date: Dec. 3, 2015

(54) REVERSE OSMOSIS SYSTEM WITH VALVES FOR CONTROLLING A WORK EXCHANGER SYSYEM

(71) Applicant: I.D.E. TECHNOLOGIES LTD., Kadima (IL)

(72) Inventors: Vitaly LEVITIN, Haifa (IL); Boris LIBERMAN, Even Yehuda (IL)

(73) Assignee: I.D.E. Technologies Ltd.

(21) Appl. No.: 14/652,370

(22) PCT Filed: Dec. 11, 2013
(86) PCT No.: PCT/IB2013/060810

§ 371 Date: Jun. 15, 2015

(30) Foreign Application Priority Data
Dec. 14, 2012 (GB) 1222615.5

(51) Int. Cl. B01D 61/02; C02F 1/44; B01D 61/12

(52) U.S. Cl. CPC B01D 61/025; B01D 61/12; C02F 1/441; C02F 2103/08

(57) ABSTRACT

A system and method for the structure and operation of a work exchanger system in a reverse osmosis plant is disclosed. The work exchanger system is characterized by a an array of multiple work exchanger chambers each being individually controlled and operated to a meet an aggregate need of pressure recovery by the entire system. Each work exchanger chamber is characterized by at least one valve having a bypass system which is configured to equalize pressure on both sides of the valve. Such an equalizing process's delays are monitored and controlled by the central systems' controlling system to create no restrictions to reject high pressure brine flow in a reverse osmosis system at any given time.

### TECHNICAL FIELD

The present invention relates to a multiple valves device, for directing the flow of fluid in a work exchanger system and more particularly, to an array of multiple work exchangers, operating in a controlled dwelling time to synchronize pistons' power strokes and exhaust strokes in order to continuously consume, recover and direct high pressure reject stream of a reverse osmosis system.

### BACKGROUND

As demand for potable water grows and energy costs increase, the energy efficient and scalable design of the seawater reverse osmosis process, makes it the preferred desalination process in many regions around the world. Energy is the largest operating cost in any reverse osmosis facility. Energy recovery devices are critical to maintain the cost effectiveness of reverse osmosis facilities. Efficiency, complexity, reliability, maintainability, operability and costs of the energy recovery system play a critical role in the ability to recover pressure energy from reject stream of a reverse osmosis process, which stream can represent 60% or more of the total energy required to pump a feed stream up to the pressure needed for reverse osmosis.

Tonner discloses in U.S. Pat. No. 5,306,428 a rotary valving device used to direct brine to or from different work exchanger chambers. However, the rotary valve device of Tonner is not hydraulically balanced and this is a major disadvantage. Lack of hydraulic balance in the Tonner device causes excessive wear on the sealing surfaces due to side loads exerted on the central spool piece. Spool rotation switches between power strokes, in which high pressure brine enters the device via an inlet port and flows through the spool into the recovery cylinder and exhaust strokes, in which the internal passage in the spool connects the cylinder to an outlet port allowing low pressure feed fluid to push the piston backwards and force the low pressure brine out through the outlet port. Once the power stroke is completed, the spool turns and the cylinder pressure is decreased and equalized with the low pressure feed while exposing the spool to unbalanced side loads. Once the exhaust stroke is completed, the spool rotates back to allow high pressure brine to recover while exposing again the spool to unbalanced side loads.

A further major disadvantage of the Tonner device relates to the fact that it does not have, in its operation, an “overlap period” in which high pressure brine may be consumed and flow continuously by and into each work exchanger cylinder. This is a critical problem because the brine flow from the membrane in a reverse osmosis system must never be restricted.

Shumway teaches in U.S. Pat. No. 5,797,429, a linear spool valve device for a work exchanger system. The linear spool valve device comprises two pistons connected by a rod located inside a cylinder. By moving the linear spool valve device back and forth within the cylinder, the work exchanger ports are alternately exposed and closed and this directs flow in the proper sequence to the proper port. This varies the work exchangers' pressure out of phase, such that at least one work exchanger is at high pressure at all time, so that spool's operation is hydraulically balanced axially and thus no net axial thrust is exerted on the piston assembly of the linear spool valve device.

Since permeate production cannot be increased beyond the recovery limit of commercially available membranes, in order to increase permeate production, membranes must be added. As membrane recovery decreases, the high pressure pump has to handle more feed fluid. Using work exchangers allow expanding permeate production of existing reverse osmosis systems based on existing high pressure pumps' infrastructure. However, expanding reverse osmosis plants into mega-plants challenges existing reverse osmosis train configuration as rival factors should be considered and optimized. It is one object of the present invention to teach a unique train configuration.

### BRIEF SUMMARY

One aspect of the invention provides a work exchanger system, comprising: at least three work exchange chambers; each of the at least three work exchange chambers being configured to be connected to at least one valve; each of the at least one valve being configured to integrate a bypass channel; wherein the bypass channel is configured to equalize pressure from both sides of the valve; and a controller, wherein the controller is configured to control each of the at least one valve of the at least three work exchange chambers such that a constant and continuous flow of high pressure brine into the work exchanger system is maintained.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIGS. 1 is a high level schematic illustration of a reverse osmosis plant of the prior art.

FIG. 2 illustrates a high level schematic of an osmosis plant as described in one aspect of the present invention.

FIG. 3 illustrates parameters affecting a reverse osmosis plant size.

FIG. 3a illustrates an optimization process for selecting a cost effective number of membranes in a train, according to one aspect of the present invention.

FIGS. 4, 5, 6 illustrate a work exchanger system according to one aspect of the present invention.

FIG. 7 illustrates a control diagram of a single work exchanger chamber in a work exchanger system according to one aspect of the present invention.

FIG. 8 illustrates a control diagram of multiple work exchanger chambers in a work exchanger system according to one aspect of the present invention.

FIG. 9 illustrates a process according to at least one aspect of the present invention.

The drawings together with the following detailed description make apparent to those skilled in the art how the invention may be embodied in practice.

### DETAILED DESCRIPTION

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

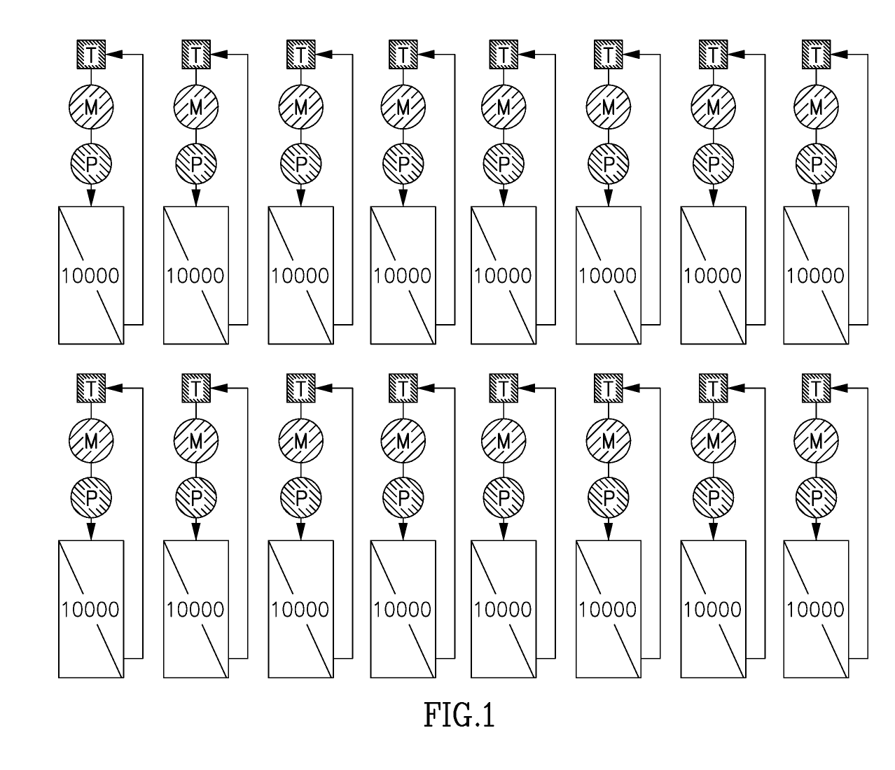

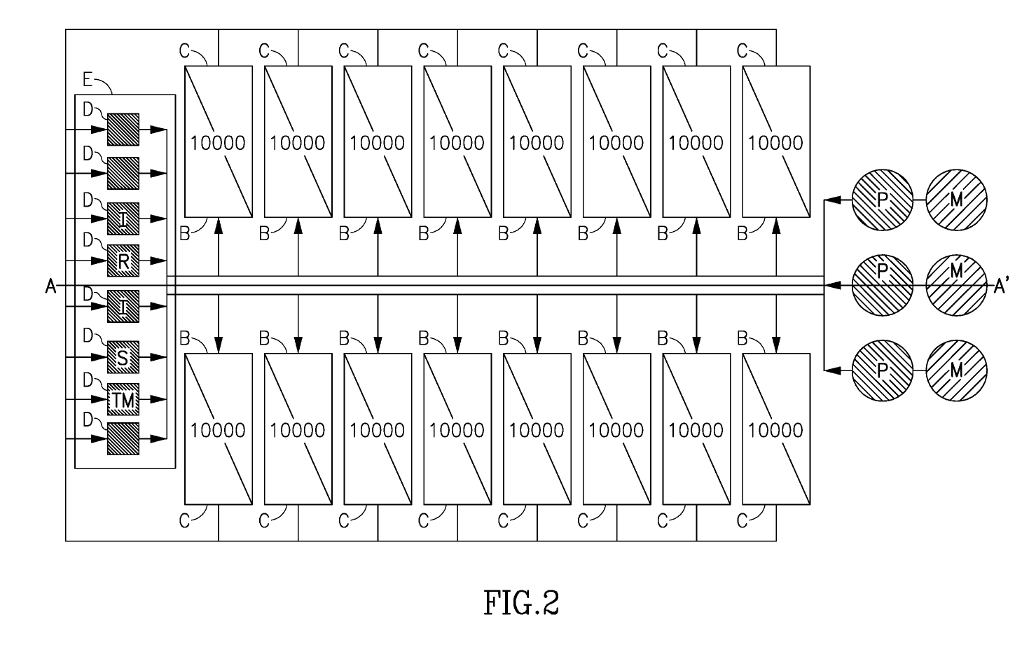

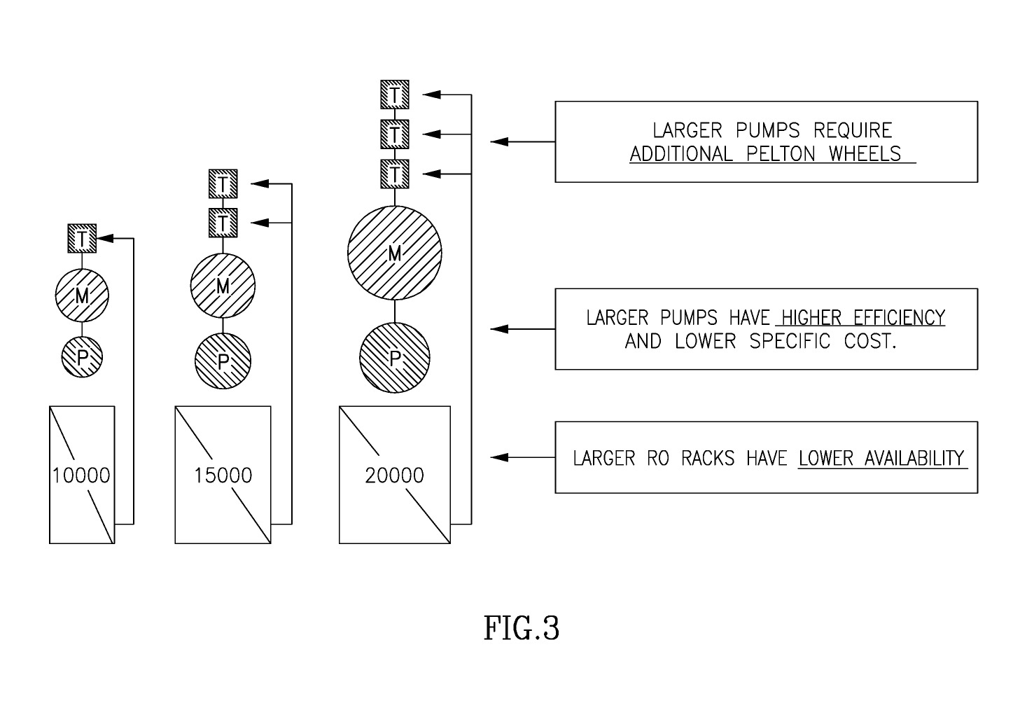

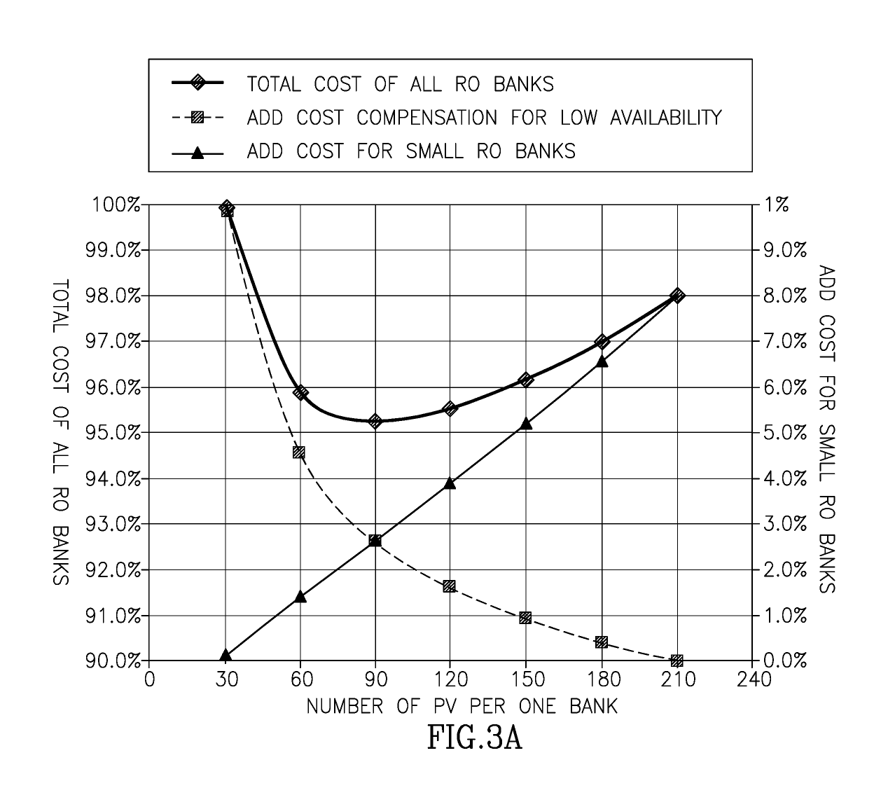

FIG. 1 illustrates a reverse osmosis plant as known in the prior art. A train of reverse osmosis membranes creates a block membrane operated by a set of a high pressure pump, a motor and a turbine. Multiple trains, each supported by its own set of a high pressure pump, a motor and a turbine could be assembled in a single plant in order to increase permeate production. As can be seen in FIGS. 2 and 3 and 3a, rival parameters are at stake when considering mega-plants configurations. For example, energy efficiency is greater when stronger pumps are involved. However, stronger pumps which operate a higher number of membranes expose the system to low availability for maintenance and increase the system vulnerability for down time due to failures. A failure of a single O-ring may stop the full train for a few hours.

FIG. 3a illustrates one aspect of the present invention. Based on an optimization process, the optimal number of membranes to create a cost effective plant has been identified. Although marginal cost per membrane diminishes as the number of membranes increases in a single train, there are increased costs associated with low availability. Accordingly, the optimal number of membranes according to one aspect of the present invention is 60-150. Preferably, the optimal number of membranes should be 80-100 while according to another aspect of the present invention the optimal number of membranes should be approximately 90.

FIG. 2 illustrates another aspect of the present invention. According to this embodiment of the invention, a pressure center configuration of a reverse osmosis plant is described. The membrane trains are configured around a common axis A-A′ which contains the high pressure feed streams to which the high pressure pumps, the work exchanger system—IRIS, and the boost pumps (not shown) are connected to membrane internal faces B. The high pressure reject brine streams are connected to the outer faces of the membranes C and are collected to their perspective work exchanger chamber within the work exchanger system, IRIS D. The advantage of this pressure center configuration is the ability to get higher energy efficiency due to the number and size of the operating high pressure pumps, as in a system with large number of membranes, while keeping a relatively small train volume, to increase availability and reduce vulnerability to down time due to membrane failures and while improving accessibility and maintainability.

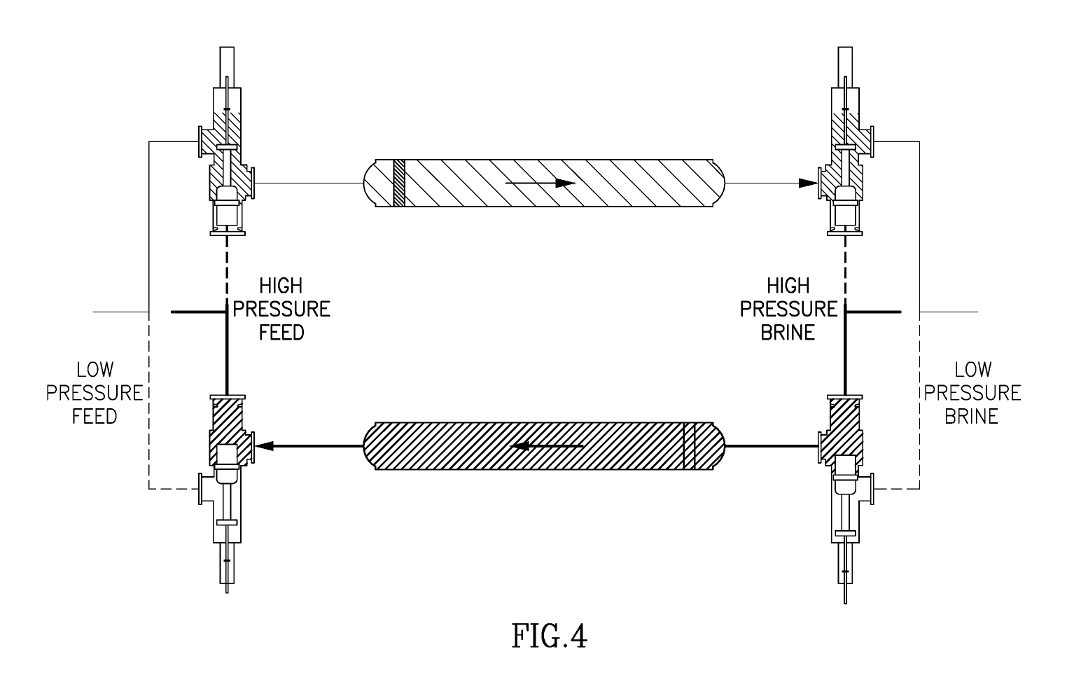

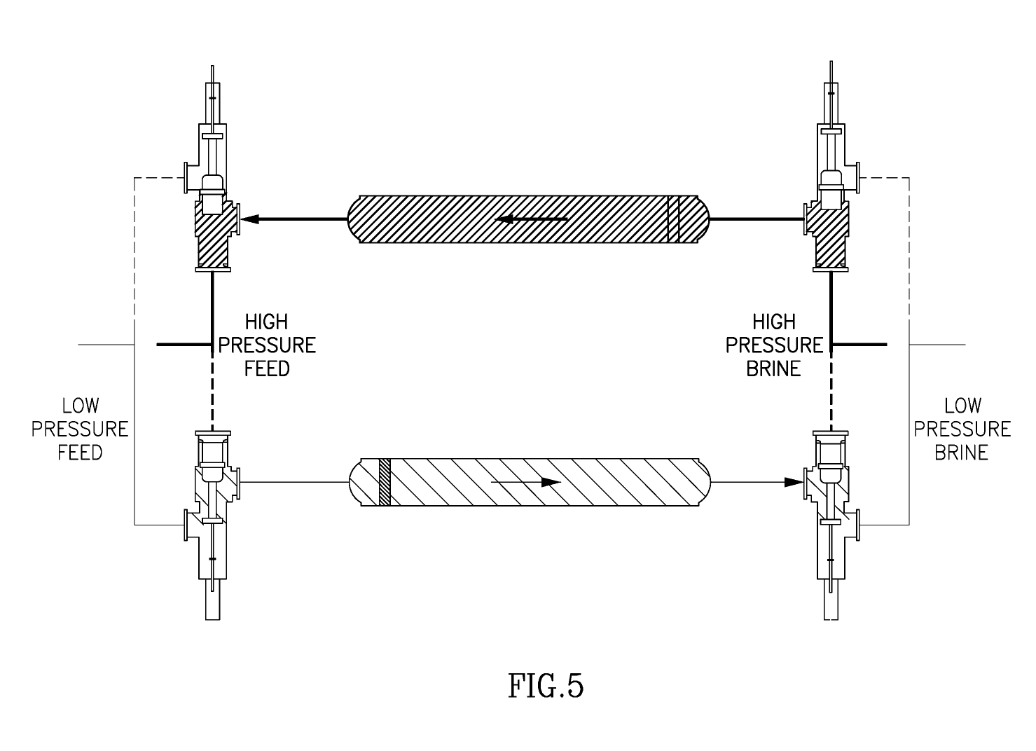

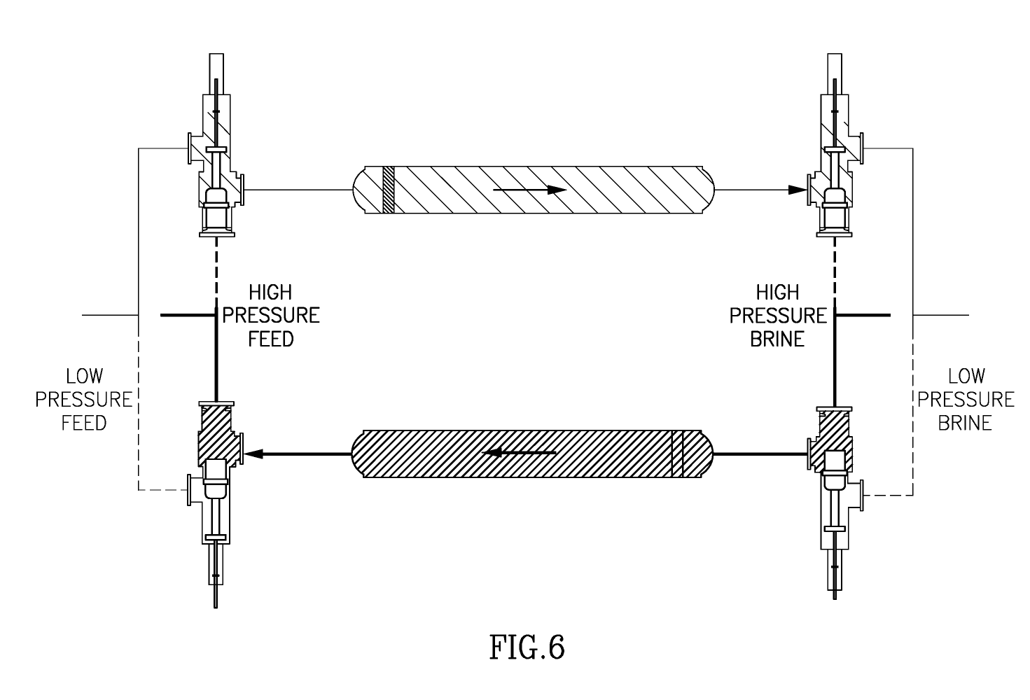

According to another aspect of the present invention, FIGS. 4, 5, and 6 illustrate the IRIS configuration and shows a single-piston linear spool valve device. According to one aspect of the present invention, a set of 4 single-piston linear spool valves, configured to be controlled by a central processing center, are capable of operating a dual chamber work exchanger system. Each set of dual chambers, element D in FIG. 2, can be used in parallel as a stack of elements, element E in FIG. 2, to support a full pressure center system. Such a single dual chamber element or a stack of elements, according to one aspect of the invention, may be separated but in close proximity to the membrane pressure center assembly while keeping convenient accessibility both to the membrane and to the elements.

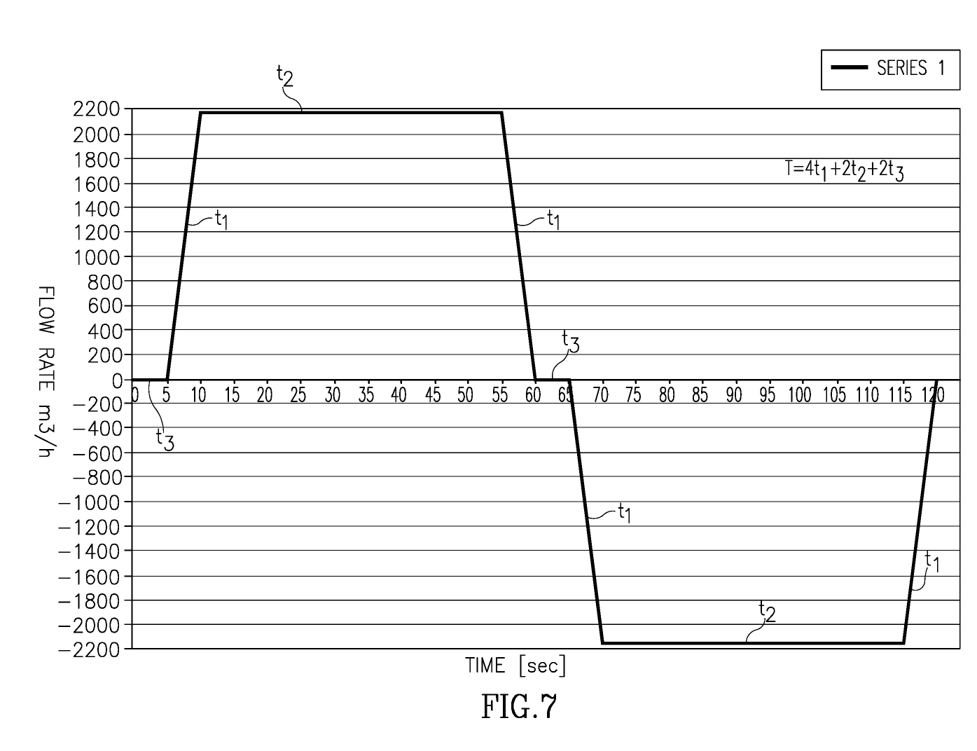

FIG. 7 illustrates a control diagram according to one aspect of the present invention. FIGS. 7a, b, and c show, according to one aspect of the present invention, detailed calculations for controlling 12 work exchangers in such a way that at any given time the total reject high pressure brine stream of a reverse osmotic system is entirely and continuously absorbed, consumed, recovered and directed by the work exchanger system so that there are no interrupts or dead time in which the work exchanger system cannot treat or absorb high pressure brine stream rejected from the membrane. According to one embodiment of the present invention, 12 such work exchanger chambers are connected through valves having a bypass mechanism to equalize the pressure on both sides of the valve prior to its position switch. Equalizing pressure between both sides of the valve is critical to its proper performance and life cycle and may ensure a more reliable and efficient work exchanger system and therefore a cost effective reverse osmosis system, with less down time and reduced energy consumption. Working with such valves in this configuration creates a non trivial problem due to time delays caused by the time it takes to equalize the pressure between both sides of the valve prior to its operation. In order to meet the strict requirements for full and continuous consumption and process of the entire high pressure brine stream, according to one aspect of the present invention, there is a redundancy in the total number of the work exchanger chambers. According to one aspect of the invention, an even number of work exchanger chambers is required. At any given time up to only half of the total even number of the work exchanger chambers is dedicated to a power stroke in which high pressure brine is recovered into high pressure seawater feed. At the same time the second half of the total even number of chambers is dedicated to an exhaust stoke, in which low pressure feed water is recovered to eject low pressure brine content from the work exchanger chamber. According to another aspect of the present invention, a stroke has a time cycle of T. During this time cycle the internal piston of the work exchanger chamber moves from one side of the chamber to the other. According to another aspect of the present invention, the time cycle of a power stroke is equal to the time cycle of an exhaust stroke. The time cycle of a stroke can be controlled and changed by the controller of the system to meet dynamic system performance demands and/or permeate production demands.

According to yet another embodiment of the present invention, any number, even or odd, of work exchanger chambers can be connected and controlled by the present method, understanding the inter-related dependency between different parameters of the system. Work exchanger chamber geometry and controlling system characterize t1, t2, t3, T and maximum flow Qmax. Once understood, a mix of different types and sizes of work exchanger chambers may be used and controlled in such a way in order to achieve one of the purposes of the present invention which is an equal flow rate at any given time between all work exchanger chambers operated at any given time in a power stroke state and all work exchanger chambers operated at such given time in an exhaust stroke state. At any given time, each one the work exchanger chambers, whether in a power stroke state or in an exhaust stroke state, may work in its Qmax state or in any other output state whether positive or negative. The system should be designed and controlled in such a way that at any given time the aggregate amount of all reject high pressure brine stream equals the aggregate amount of pressure recovery so that the system may work in a continuous mode without any dead time which imposes any restriction on the high pressure brine stream.

Based on the cross sectional area of the work exchanger chambers, the internal piston is designed to sealingly move along the chamber and reduce to a minimum the mixing losses. Valves are preferably chosen to reduce to a minimum the leakage pressure energy losses where high pressure brine is directly discharged through the low pressure brine stream without any pressure recovery.

FIG. 7 illustrates a non-limiting example of a time-flow diagram of an individual work exchanger chamber according, to one aspect of the present invention. According to this example, t3 represents time durations characterized by zero flow rates. During these time periods, the individual work exchanger chamber undergoes a pressure equalization process as a result of the valve's bypass system. Times t1's represent rising and falling time durations of the piston in which the flow grows from zero, flow Q0, to the time it takes the piston to build up to the then defined maximum flow rate Qmax, or the time it takes the piston to reduce the flow from the maximum flow rate Qmax, back to zero flow Q0. In other words, t1's represent the durations it takes the individual work exchanger chamber to switch from time duration t3, which is characterized by zero flow Q0, to time duration t2 which is characterized by maximum flow Qmax or from time duration t2 which is characterized by Qmax to time duration t3 which is characterized by Q0. According to one aspect of the present invention, the rising and falling times of the individual work exchanger chamber may be equal. However, according to other embodiment of the present invention, the rising and falling times of the individual work exchanger chamber may not be equal. According to one aspect of the present invention, the flow profiles of an individual work exchanger chamber during rising time and falling time may be equal. However, according to other embodiments of the present invention, the flow profiles of an individual work exchanger chamber during the rising time and falling time may not be equal. According to one aspect of the present invention, the flow profiles of an individual work exchanger chamber during the rising time and falling time may be linear. However, according to other embodiments of the present invention, the flow profiles of an individual work exchanger chamber during the rising time and falling time may not be linear and can take any other form or shape. According to one aspect of the present invention, the time durations t2 are characterized by the maximum flow rate Qmax. Such a flow rate may be in both sides of the individual work exchanger chamber. One flow direction may be defined as a positive flow while the opposite flow direction may be defined as a negative flow. According to one embodiment of the present invention, the positive flow direction is defined as the pressurized seawater feed stream during pressure recovery process in a power stroke. In this embodiment, the negative flow direction is defined as the low pressure seawater stream during an exhaust stroke. According to one embodiment of the present invention, the positive Qmax and the negative Qmax of an individual work exchanger chamber are equal. According to another embodiment of the present invention, the positive Qmax and the negative Qmax are not equal. According to another embodiment of the present invention, the positive Qmax may be bigger or smaller than the negative Qmax. Time durations t2's in which the flow rate is characterized by positive or negative Qmax may be equal to both positive and negative flow directions or not.

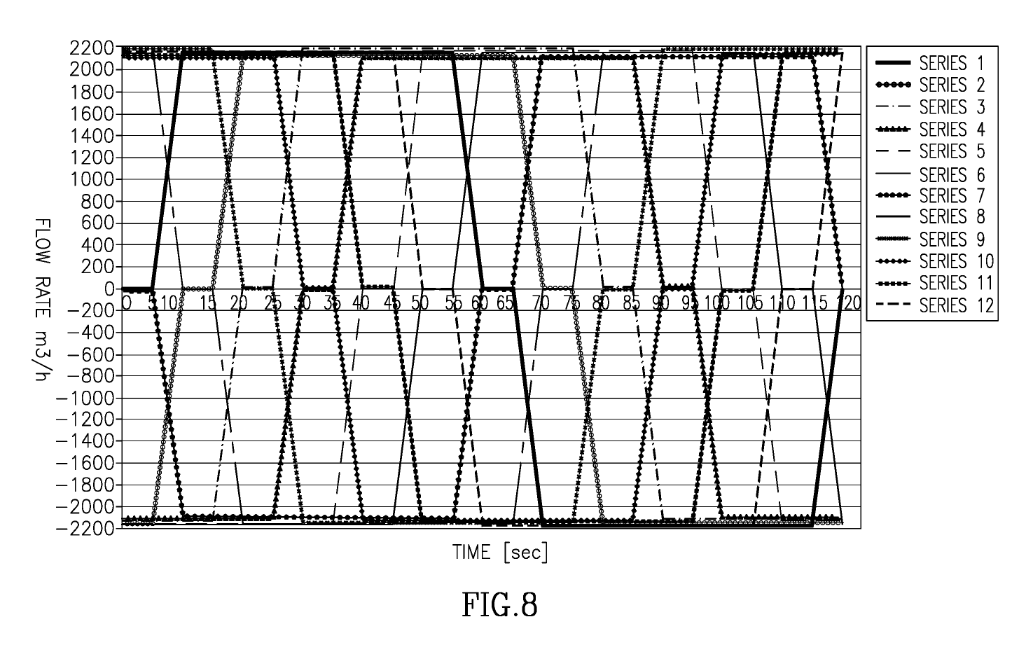

FIG. 8 illustrates one aspect of the present invention by a non-limiting example of a time flow diagram of a work exchanger system characterized in a multiple work exchanger chambers configuration. A time flow diagram may represent a controlling process to manage and control multiple work exchanger chambers' working profiles in order to achieve one purpose of the present invention. Controlling the sequence of the operating work exchanger chambers as well as the number of operating work exchanger chambers at any given time and state of each work exchanger chambers at any given time represents one aspect of the present invention. Piston's and chamber's geometry and structure define, among other things, maximum flow capacity to be produced by the moving piston at a certain piston speed. Controlling the system characteristics, chamber's structure and differential pressure across the piston defines the rising time t1 in which it takes the piston to move from time 0, where there is zero flow rate Q0, to time t1, achieving a maximum flow rate Qmax. Controlling the system characteristics, chamber structure and differential pressure across the piston also defines a falling time t1, in which it takes the piston to move from time t2, characterized by Qmax, to time t3, in which the piston's speed is reduced to 0 and flow is also reduced to zero, Q0. During time t3, the integrated bypass system of the valve equalizes the pressure on both sides of the valve. According to one aspect of the present invention, rising time t1 and falling time t1 are equal. According to another embodiment of the present invention, the rising time t1 and falling time t1 are not equal. The stream profile during the rising time t1 which builds up the flow rate from Q0 to Qmax may be linear or in any other known form or shape. The same is true of falling time t1. Once these profiles are known and predicted, a system according to one aspect of the present invention may be designed in which at any given time the aggregate flow from all the work exchanger chambers which are currently experiencing falling time t1 are equally balanced with equal aggregate flow rate which is produced at such time by all work exchanger chambers which are experiencing at such time rising time t1.

According to one aspect of the present invention, at any given time up to half of the chambers are in a power stroke state while up to the second half of the chambers are in an exhaust stroke state. According to one aspect of the present invention, all the chambers which are in a power stroke are working at their maximum flow rate. This means they are operating somewhere along their respective individual time interval t2. In yet another aspect of the present invention, at least two chambers which are working in a power stroke mode are operating one in a rising state and the second in a falling state. This means that one is working somewhere along its individual time interval of t1 and increasing the flow rate while the other is working somewhere along its individual time interval t1 and reducing the flow rate. In yet another embodiment of the present invention, in which rising time and falling time are equal, the chamber working in the rising state is completely synchronized with the chamber working in the falling state such that the sum of the two constantly equals the maximum flow rate of one of them or any other defined maximum flow rate Qmax. Therefore, according to this aspect of the present invention, at any given time the sum of the chambers working at maximum flow rate and the chambers working in any of the rising or falling states is constant.

According to another aspect of the present invention, there may be redundancy in the number of the chambers to allow full compensation of all accumulated delay time caused by the time it takes to equalize the pressure on both sides of the valves before any valve position change. In one embodiment of the invention, and along one non-limiting example, the delay time may be about 5 seconds. In this embodiment and non-limiting example, the rising and falling time of the chamber may also be 5 seconds while the dwelling time according to this non-limiting example may be 55 seconds. In this non-limiting exampled embodiment the chamber may produce a maximum flow only for about 45 seconds. In the non-limiting example of FIGS. 7a, 7b and 7c, a configuration of 12 chambers is disclosed. In this non-limiting example, the total system outflow may be 10,800m³/h and may be achieved by having an average of 900 m³/h per chamber with a maximum outflow of 1,260 m³/h per chamber.

In yet another aspect of the present invention different chambers' and pistons' dimensions can be used to achieve different maximum flows Qmax characterizing each individual chamber. Therefore, configurations of different number of chambers having different rising and falling times as well as different dwelling time which are related, among other things, to chamber geometry, may achieve different permeate production rates and absorb different dynamic fluctuations in system demands and performances.

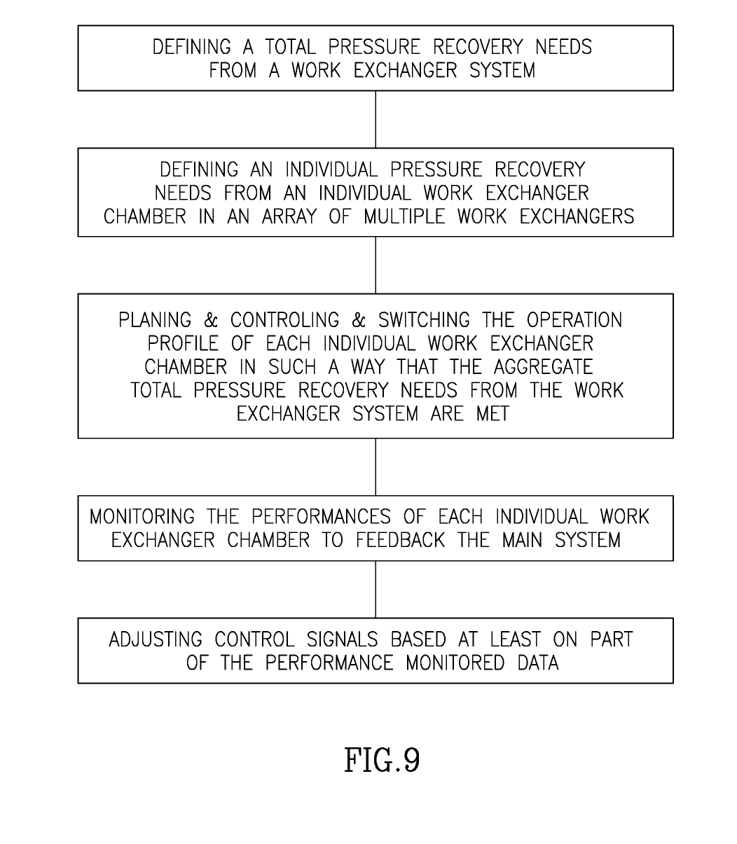

Another aspect of the present invention is a system and method to operate a reverse osmosis plant having the above mentioned work exchange system. As illustrated in FIG. 9, a process according to one aspect of the present invention is disclosed. It should be mentioned that steps in this process may be added, deleted or combined. According to one embodiment of the present invention, the total pressure recovery requirements of a work exchanger system is defined at a certain time. Based on the then defined total pressure recovery needs from the work exchanger system and based on availability, operability, state, condition, performance or characteristics of each individual work exchanger chamber, a certain pressure recovery profile is defined for each individual work exchanger chamber in an array of work exchanger chambers. Among other things, an individual pressure recovery profile is defined for each individual work exchanger chamber based, at least in part, on at least one of its t1, t2, t3 or T characteristics. Based on the defined individual pressure recovery profile, each individual work exchanger chamber is controlled and operated by the system. By defining the total pressure recovery needs of the entire system and by defining individual recovery needs to each individual chamber, the system calculates, plans, monitors and adjusts on and off signals to each individual chamber's valve in order to ensure a continuous and full consumption of all rejected high pressure brine stream at any given time or state in order to avoid any restriction on the high pressure brine stream. The main controller of the work exchanger system monitors the operation, state, conditions and performances of each individual work exchanger chamber by and along common sensors and parameters respectively, as known to the skilled man in the art e.g. flow rate, temperature, pressure, viscosity, salinity, PH etc. Each sensing element may be invasive or non-invasive to its target object. In addition, according to one embodiment of the present invention, each work exchanger chamber may feed back to the main system its own state, condition or performances so that the main system may redefine or readjust required pressure recovery needs for any of the individual work exchanger chambers at any given time based, at least in part, on data detected and or processed. According to another embodiment of the present invention, the sensing or controlling process further includes sensing or controlling a bypass system which is configured to be integrated with a valve. Such a process may include, according to one embodiment of the present invention, the steps of sending a signal, based on a signal from the main control system, to a valve or its related bypass system. Such a signal may, among other things and according to one embodiment of the present invention, order the bypass system to equalize the pressure on both sides of its related valve. According to another embodiment of the present invention, any change in the position of at least one valve in a work exchanger chamber is preconditioned by pressure equalization on both sides of the valve. According to another embodiment of the present invention, such a precondition may be controlled and monitored and a positive signal, or an absence of a negative signal, may be a precondition to a valve position switch. According to another aspect of the present invention, theoretical pressure equalization's duration are calculated per individual valve and its related bypass system. According to another embodiment of the present invention, the actual and real time pressure equalization's durations are monitored for each individual valve and its related bypass system at any relevant state. According to one aspect of the present invention, the work exchanger system controls, at least in part, each on an off operation order to at least one valve or bypass system in each work exchanger chamber based on the calculated or monitored pressure equalization duration of a related valve or bypass system. According to another aspect of the present invention, the work exchanger system maintains a constant aggregated pressure recovery level by switching on and off individual work exchanger chambers in an array of multiple work exchanger chambers. Such on and off switching orders are based at least in part, on the any of t1, t2, t3 or T of each individual chamber, in order to meet the total defined demand for pressure recovery by the entire system. According to another aspect of the present invention, the work exchanger system may control, operate or monitor any subset of the total work exchanger chambers within the array so that each individual work exchange chamber operation is optimized in light of its capabilities at any given time and in light of the total pressure recovery demand at any given time.

In the above description, an embodiment is an example or implementation of the invention. The various appearances of “one embodiment”, “an embodiment” or “some embodiments” or “embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Furthermore, it is to be understood that the invention can be carried out or practiced in various ways and that the invention can be implemented in embodiments other than the ones outlined in the description above.

The invention is not limited to those diagrams or to the corresponding descriptions. For example, flow need not move through each illustrated box or state, or in exactly the same order as illustrated and described.

Meanings of technical and scientific terms used herein are to be commonly understood as by one of ordinary skill in the art to which the invention belongs, unless otherwise defined.

While the invention has been described with respect to a limited number of embodiments, these should not be construed as limitations on the scope of the invention, but rather as exemplifications of some of the preferred embodiments. Other possible variations, modifications, and applications are also within the scope of the invention.

1. A reverse osmosis system, comprising:
at least three work exchange chambers;
each of the at least three work exchange chambers being configured to be connected to at least one valve;
each of the at least one valve being configured to integrate a bypass channel;
wherein the bypass channel is configured to equalize pressure from both sides of the valve;
a controller; and
wherein the controller is configured to control each of the at least one valve of the at least three work exchange chambers such that a constant and continuous flow of high pressure brine into the work exchanger system is maintained.

2. The reverse osmosis system of claim 1, wherein the system comprises a centre pressure reverse osmosis system.

3. The system according to claim 1, wherein the at least one valve of the at least three work exchanger chambers is configured to switch between on and off positions after the pressure of the high pressure brine on both sides of the valve is equal.

4. The system according to claim 3, wherein the switch between on and off positions of the at least one valve of the at least three work exchanger chambers, causes a time delay t4.

5. The system according to claim 4, wherein the time delay delays the switch of at least one work exchanger chamber to switch from a power or exhaust stroke to exhaust or power stroke accordingly.

6. The system according to claim 5, wherein the controller controls the at least one valve of the at least three work exchange chambers such that the total inflow of the high pressure brine into the work exchange system and the total outflow of the high pressure brine from the work exchanger system is equal at any given time.

7. The system according to claim 6, wherein the work exchanger system is configured to be connected to a reverse osmosis system.

8. The system according to claim 7, wherein the work exchanger system is configured to process continuously the total reject high pressure stream of the brine of the reverse osmosis system.

9. A system according to claim 1, wherein the at least three work exchanger chambers is configured to comprise a piston.

10. A system according to claim 9, wherein the piston is configured to sealingly move within and along the work exchanger chamber.

11. A system according to claim 10, wherein the piston is configured to move from one side of the work exchanger chamber to the opposite side of the work exchanger chamber in dwelling time T.

12. A system according to claim 11, wherein the work exchanger chamber and the piston have a rising time t1 and a falling time t2.

13. A system according to claim 12, wherein t1 equals t2.

14. A system according to claim 12, wherein the piston is configured to produce a constant flow during the operation between time t1 and T-t2.

15. A system according to claim 1, wherein the number of work exchanger chambers is an even number.

16. A system according to claim 15, wherein at any given time no more than half of the even number of work exchanger systems are in a power stroke.

17. A system according to claim 16, wherein all of the power strokes are at a maximum power.

18. A system according to claim 16, wherein at least one power stroke is within rising time t1 and at least one power stroke is within falling time t2.

19. A system according to claim 18, wherein the rising time of the at least one power stroke is configured to timely compensate the falling time of an at least second power stroke such that the total recovery rate remains constant.

20. A system according to claim 1, wherein the number of work exchanger chambers is 12, dwelling time is 55 seconds, rising time is 5 seconds, falling time is 5 seconds and delay time is 5 seconds.

21. A system according to claim 20, wherein the total output of the work exchanger system is configured to be around 10,800 m³/h of high pressure brine.

22. A system according to claim 21, wherein the average output of a single work exchanger chamber is 900 m³/h of high pressure brine.

23. A system according to claim 22, wherein the maximum output of a single work exchanger chamber is 2,160 m³/h of high pressure brine.

24. A reverse osmosis system, comprising:
at least one reverse osmosis train;
the at least one reverse osmosis train being configured to be connected to a work exchanger system;
said work exchanger system being according to claim 1.
